(19) United States
(12) Patent Application Publication
(10) Pub. No.: US 2021/0398394 A1
(43) Pub. Date: Dec. 23, 2021

(54) BLACKJACK DUEL

(71) Applicant: HexiGames AB, Vaxjo (SE)

(72) Inventors: Joel Wikell, Vaxjo (SE); Benjamin Bjorklund, Vaxjo (SE); Magnus Dahlin, Vaxjo (SE); Robin Lindell, Vaxjo (SE)

(21) Appl. No.: 17/351,491

(22) Filed: Jun. 18, 2021

Related U.S. Application Data
(60) Provisional application No. 63/041,561, filed on Jun. 19, 2020.

(51) Int. Cl. G07F 17/32

(52) U.S. Cl. CPC G07F 17/3279; G07F 17/3293; G07F 17/3244; G07F 17/3237

(57) ABSTRACT

Allowing players to duel head-to-head rather than play against a dealer is first presented by the blackjack duel system. Presenting a part of the deck to the players and reducing the size of the deck to allow players' skill to come more into play is also different than what is normally found in the blackjack industry. Allowing for asynchronous matchmaking (matching players together on their own schedule) is also different than existing systems. Thus, the blackjack duel system allows players to have a more exciting game of blackjack, played more comfortably in their own environment and on their own schedule. Players can measure their skill against other players and use that skill to win prizes and progress on a leaderboard.

### CROSS-REFERENCE TO RELATED APPLICATIONS

The present application claims the benefit of U.S. Provisional Patent Application No. 63/041,561 (Attorney Docket No. HEXIGAMES001) entitled “BLACKJACK DUEL,” and filed on Jun. 19, 2020, which is hereby incorporated by reference.

### BACKGROUND

Blackjack is the American version of a popular global banking game known as Twenty-One, whose relatives include Pontoon and Vingt-et-Un. It is often a comparing card game between one or more players and a dealer, where each player in turn typically competes against the dealer. Players do not typically compete against each other. The game is played with one or more decks of 52 cards and is the most widely played casino banking game in the world.

Players are each dealt two cards, face up or down depending on the casino and the table. In the U.S., the dealer is also dealt two cards, normally one up (exposed) and one down (hidden). In most other countries, the dealer only receives one card face up. The value of cards two through ten is their numeric value (2 through 10). Face cards (Jack, Queen, and King) are all worth ten. Aces can be worth one or eleven. A hand's value is the sum of the card's values. Players can draw more cards to improve their hands. A hand with an ace valued as 11 is called “soft,” meaning that the hand will not bust by taking another card. The value of the ace will become one to prevent the hand from exceeding 21. Otherwise, the hand is called “hard.”

Once all the players have completed their hands, it is the dealer's turn. The dealer hand will not be completed if all players have either busted or received blackjacks (a score of exactly 21). The dealer then reveals the hidden card and must hit until the cards total up to 17 points. At 17 points or higher the dealer must stay. At most tables, the dealer also hits on a “soft” 17, i.e., a hand having an ace and one or more other cards totaling six. They players are betting that they have a better hand than the dealer. The better hand is the hand where the sum of the card values is closer to 21 without exceeding 21. The detailed outcome of the hand follows. If the player is dealt an Ace and a ten-value card (called a “blackjack” or “natural”), and the dealer does not, the player wins and usually receives a bonus. If the player exceeds a sum of 21 (“busts”); the player loses, even if the dealer also exceeds 21. If the dealer exceeds 21 (“busts”) and the player does not, the player wins. If the player reaches a final sum higher than the dealer and does not bust, the player wins. If both dealer and player receive a blackjack or any other hands with the same sum, called a “push”, no one wins.

People that love the game of blackjack would often like to play alone or with others, even when there is no dealer available or when they are outside of a casino environment. The regular game of blackjack does not provide a straightforward way to do this and does not provide the player with a definitive sense of how the user is doing. For example, there is no sense of score or progress when the user plays alone, and the player has no way to bet and earn money or other prizes or to measure the player's skill against someone else's.

### BRIEF DESCRIPTION OF THE DRAWINGS

FIG. 1 is a block diagram that illustrates components of the blackjack duel system, in one embodiment.

FIG. 2 is a flow diagram that illustrates processing of the blackjack duel system to carry out a duel, in one embodiment.

FIG. 3 is a flow diagram that illustrates processing of the blackjack duel system to deal the same cards to two dueling players, in one embodiment.

FIG. 4 is a display diagram that illustrates cards dealt in a round of a blackjack duel, in one embodiment.

FIG. 5 is a display diagram that illustrates a second dealing of cards in a round of a blackjack duel, in one embodiment.

FIG. 6 is a display diagram that illustrates a subsequent round of a blackjack duel, in one embodiment.

FIG. 7 is a display diagram that illustrates a conclusion of a blackjack duel for one player, in one embodiment.

### DETAILED DESCRIPTION

A blackjack duel system is described here that provides a new variation of blackjack in which two players battle head-to-head without a dealer to achieve the largest score and in some variations win money or other prizes. The blackjack duel system can be played physically with real cards but typically is computerized and played on a personal computer with or without a network. When networked, players at separate locations can play head-to-head as if in the same room. For example, players from different countries can play a game of blackjack duel over the Internet. In some variations, the players do not even have to play at the same time. The blackjack duel system may allow one player to play and receive a score and have a second player join later to battle against that player, the result being determined by comparing the two players' scores when they are both done playing a hand or series of hands.

In some embodiments, the blackjack duel system uses a single deck of 52 cards, unlike casinos, which often use seven decks of cards to confuse card counters. In blackjack duel, it is desirable to give the player some advantage in counting cards so that the player can apply more of his or her own skill to get a better score. In casinos, it is more desirable to push players closer to average by making it unlikely that they can apply any skill. Casinos make money by tilting averages in their favor. Blackjack duel increases fun by allowing players to apply their personal skill to do better in the game and thereby to do better against other players. Having a single deck helps this as well as do some of the other variations described here, such as dealing some cards that are not in play face up to encourage counting. The deck may be used until the cards run out then shuffled or may be reshuffled at the end of each hand.

In some embodiments, the blackjack duel system presents some amount of the deck, often half, to the players face up where the player(s) can see these cards. As described previously, this increases the tilt of the game towards the players' skill because the players are better able to use the cards they see to predict the cards they do not see that are being dealt to them. If the player knows there are only 52 cards and half of them are visible, the user can infer many things. For example, if four aces are visible then the player knows that there are no more aces in the deck to be dealt. If the visible cards include a significant percentage of face cards, the remaining cards are less likely to have face cards, and so forth. The player can use these inferences and the player's own probability calculations to predict with higher reliability what cards are likely to come next from the hidden part of the deck.

In some embodiments, each player is presented with the same cards and the same opportunities. For example, each player may be shown the same half of the deck as visible and may be dealt the same cards in the same order. Even though players may make different decisions from this starting point (e.g., one may hit seeing a third card from the hidden deck while another stays and does not see the third card until the round is over), they have the same opportunity and a level playing field. The players in this variation are not battling a dealer or the deck but are battling each other to try to do better in score or outcome.

Scoring can work in many ways and may vary in different implementations of the blackjack duel system. In some embodiments, players start with 1,000 chips and can bet at each deal of a new card. For example, a player might be dealt a face card and bet 50/100/150/200 chips. At the end, the player with the better hand (i.e., closer to 21 without busting) is awarded the amount bet or some other amount related to how well the player did. The score can be adjusted in many ways to allow for interesting incentives to the player. For example, busting can be heavily penalized to try to encourage players not to bust or can be only mildly penalized so that players take more risk. Events like splits (where the user is dealt two of the same cards and elects to play each card as two hands separately) can be rewarded more heavily or less to adjust the incentives for the players. An operator of the system may adjust configuration details to allow the game to work in many variations, though in whatever variation the game is presented with a similar configuration to both (or more) players so that they have the same relative likelihood of success and can apply their skills to do better or worse than other players.

In some embodiments, there is a time component that limits how many hands a player can play. For example, each player may be given one minute to play as many hands as possible and may receive a total score at the end. This can advantage a player who can quickly assess the visible cards and play more hands, but it may also disadvantage that player if the player uses that information poorly and thus uses more hands to lose more points. At the end of the minute or other time limit, one player may have played 10 hands while the other may have played five. This leads to a different score for these players. If the one that played five hands did great in each round, then that player may still have a higher score than the player that played 10 but possibly busted each time or most of the time. This variation allows for more fun and excitement for the players. Note that while the time may be limited, the time need not be served in the same minute for each player. In other words, one player could play his or her minute in the morning and a second player could show up in the evening to play against the first player. Each player faces the same conditions, but the game allows the players to play on their schedule, and thus allows more matches for a player by not forcing players to be present at the same time.

In some embodiments, game progress is saved by the blackjack duel system until a second player shows up to play against a first player. The first player could play many rounds before a second player is found to play against the first player. In some cases, the first player may have a specific second player in mind that the first player likes to play against and may wait for that player to be available. In some embodiments, the rounds may play like a turn-based game, where each player can show up on the player's own schedule, complete a few more hands, and they game moves on over time as each player is available to make progress. Thus, a game could span many sessions over many days and could even go on for a long time. In some embodiments, the blackjack duel system may arrange tournaments where ranked players battle against one another for progress on a leaderboard. For example, the system may arrange for the top 20 players to battle against each other to choose a champion.

Allowing players to duel head-to-head rather than play against a dealer is first presented by the blackjack duel system. In fact, the blackjack duel system requires no human dealer at all, thus freeing the players from what can be a significant limitation to when and where they can play. Presenting a part of the deck to the players and reducing the size of the deck to allow players' skill to come more into play is also different than what is normally found in the blackjack industry. Allowing for asynchronous matchmaking (matching players together on their own schedule) is also different than existing systems. Thus, the blackjack duel system allows players to have a more exciting game of blackjack, played more comfortably in their own environment and on their own schedule. Players can measure their skill against other players and use that skill to win money, prizes, or simply bragging rights and progress on a leaderboard.

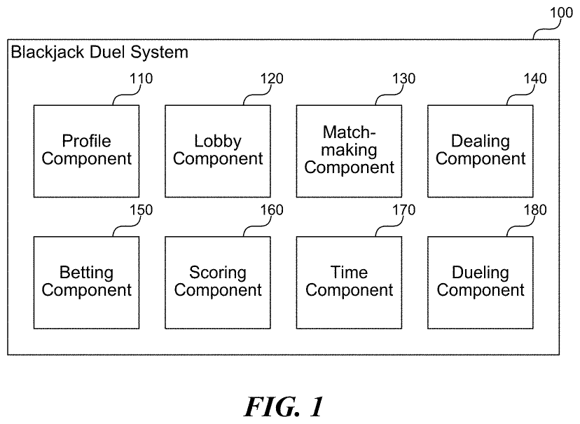

FIG. 1 is a block diagram that illustrates components of the blackjack duel system, in one embodiment. The system 100 includes a profile component 110, a lobby component 120, a matchmaking component 130, a dealing component 140, a betting component 150, a scoring component 160, a time component 170, and a dueling component 180. Each of these components is described in further detail herein.

The profile component 110 manages profile information for each user of the system 100, including a username, login information, and winnings balance. The profile component 110 allows a user to use the system 100 over time and keep a balance of winnings across many duels. The profile component 110 may also store a user image, which may be an avatar, a photograph of the user, a drawing, or other representation of the user. The login information may include a password, digital key, two-factor authentication information, or other information that the system 100 uses to determine that someone logging into the system 100 is who they say they are. The winnings balance may be in the form of points, national currency of a government jurisdiction, virtual currency, cryptocurrency, or other form of legal tender. The profile component 110 may allow the user to transfer all or part of the winnings balance to a bank account, gift card, merchandise, services, or other form of holding value, and may also allow the user to transfer money from somewhere else to the winnings balance for use playing the game.

The lobby component 120 presents multiple game tiers to a player from which the player selects one tier, wherein each tier has a different entry fee and winning amount that the player will win if the player wins a duel. For example, the lobby may display a $1 tier, a $5 tier, a $10 tier, a $50 tier, and a $100 tier. Each tier has an entry fee that is generally slightly more than half of the winning amount, such that both players in a duel pay enough to fund the winnings and pay the operator of the system 100 a profit for operating the system 100. For example, the $1 tier may have an entry fee of $0.60, the $5 tier may have an entry fee of $3, and so forth. Each player in a duel will pay the entry fee, and the winner will receive the winning amount. The lobby component 120 may also present a tier that is based on game currency and allows the player to practice without spending real money. For example, the profile component 110 may give a new player joining the game 10 units of game currency, each of which can be used to play a practice round without spending any money. This increases the player's comfort level with the system 100 without the risk of losing any money.

The matchmaking component 130 finds an opponent for the player based on the selected game tier so that the player and opponent can enter a duel, each duel having multiple rounds. The matchmaking component 130 may use a variety of methods to find an opponent, such as random selection, matching players of similar skill or experience, matching players by geographic location or language, and so forth. The matchmaking component 130 may also help players find opponents they have played against before and may want to have a rematch against. This can also be used to allow friends to play each other rather than an opponent they do not know. In some embodiments, the system 100 may have periodic tournaments during which players are matched based on a leaderboard and past performance to allow determining a grand champion of the game.

The dealing component 140 deals cards for each duel round and tracks the cards dealt to present the same cards to the player and opponent for each duel round. A feature of each duel is that the player and opponent are presented with the same situation with respect to the cards, and that their differing actions and skill will allow one to be victorious against the other. For example, two players presented with cards totaling 16 may make a different decision as to whether to hit or stand and/or may bet a differing amount based on their assessment of the likely outcome. Dealing may include dealing according to a standard blackjack game or one or more variations selected by the players or system 100. For example, the dealing component 140 may present some cards face up that are not in play (e.g., not part of the player or dealer's hand) to allow the players to make educated guesses based on probability theory about which card will come up next from the undealt cards. The dealing component 140 may produce and store a log of which cards are dealt in each round so that the player and opponent can play at different times and be presented the same cards. For example, the player may finish his performance in the duel before the opponent ever plays the first hand, but both will face the same cards.

The betting component 150 receives from the player a bet for each duel round indicating an amount to be won or lost based on whether the player wins the duel round. The betting component 150 may provide a set of buttons in a user interface from which the player can select from a set of common bet amounts or may allow the player to enter a custom amount for the bet. The bet comes from an initial balance given to each player at the beginning of each duel. The balance may be in various units, such as game points, government-backed currency, cryptocurrency, and so on. The betting component 150 awards the player an amount of money based on the bet and the outcome of the round. If the player wagers 50 points and wins the round, then the player wins 50 points in addition to getting to keep the 50 points wagered. If the player wagers 50 points and loses the round, then the player loses the 50 points wagered. The opponent faces the same situation as the player whenever the opponent plays and can wager more or less than the player wagers and may therefore win more or less based on the outcome of each round.

There may be a separation of money and points that facilitates the duel, unlike traditional blackjack where money is a sufficient way to track game progress. For example, a player may enter a $1 game tier so that $1 is the only amount that can be won, and $0.60 entry fee is all that can be lost. However, for the duel the system may assign the player 1000 points, so that the player can wager 50, 100, 250, or another amount of points each round. The system 100 can then compare the player's and opponent's points at the end of the duel to determine who won and can then award the appropriate amount of winnings. So, while the game may be played in points, the winnings may be tracked in real money. One player may end the duel with 6,000 points while the opponent ends the round with 4,000 points, and the player will win $1 because he has the higher number of points.

The scoring component 160 accumulates a player duel score and opponent duel score after each duel round that indicates a relative performance of the player and opponent. The scoring component 160 tracks game points during a duel to indicate who is more successful based on wager amount and outcome against the virtual dealer. If the player or opponent busts, then their score will go down by the wager amount. If the player or opponent beats the virtual dealer (by having a card total closer to 21 without going over), then their score will go up by the wager amount. At the end of the duel rounds (which may occur due to time or by being out of points with which to play), the player with the higher score wins the duel and was more successful overall across all the rounds. If the score of the player or opponent reaches zero or is insufficient to bet in further rounds (e.g., such as if the game imposes a 50-point minimum to play a round), then the scoring component 160 may signal an end for that player to the duel.

In some embodiments, an alternative scoring method is used that cannot be negative. This scoring method adds an additional scoring element at the end of each round that equals the net win of the round (total win minus total bet in the round). This score will never be a negative number, so even if the player lost chips in the round (bet was greater than win) this score will not decrease. At the end of the match, the scoring element and the player's remaining chips are summed up, and this sum will be the players score for the match. For example, consider a match where the player starts with 1000 chips. A new round starts, and the player bets 100 chips. The player stands and the dealer busts. The player's chips at the end of the round total 1100 (100 gained this round), and the player's scoring element is 100 (+100, 200 wins−100 bets). A new round starts, and the player bets 100. The player busts. The player's chips at the end of the round total 1000 (−100), and the player's scoring element remains 100 (±0, 0-100 is negative, so no additional score is added or deducted). A new round starts, and the player bets 100. The player splits his hand (100 additional bet). The player doubles the first split hand (100 additional bet). The player wins the first split hand but loses the second one. The player's chips at the end of the round total 1100 (+100), and the player's scoring element totals 200 (+100, 400 wins−300 bets). The match ends, and the chip total 1100 and scoring element 200 are summed up. The sum is the player's score for the match, 1300. Those skilled in the art will recognize that this and other scoring methods can be adapted to work with the system 100 to improve game balance and produce other game modes.

The time component 170 optionally places a time limit on the duel. The player and opponent receive the same time limit and can do better or worse in the duel by being faster or slower at playing rounds. A player that is fast will play more rounds and thus has an opportunity to win a higher total of points, but still may fail to do so by losing too many rounds. A player that plays slower may nevertheless win by having a stronger showing by losing fewer rounds. The time component 170 tracks how much time is left in the duel and presents new rounds to the players while more time is left. When time expires, the time component 170 ends the duel and presents the player with the final score. The time component runs separately for each player. For example, the player may get 10 minutes in the morning when he plays, and the opponent may get 10 minutes in the evening when she plays. Both face the same 10-minute limit, but do not play at the same time. The duel does not conclude until both players are done playing.

The dueling component 180 determines when the duel ends, identifies a duel victor, and awards the winning amount of the selected game tier to the duel victor. As discussed above, the duel may end based on a time limit expiring, a player exhausting points to bet with, or other reason (such as one player surrendering early). The duel ends for each player (the player and opponent) when both have had a chance to play all the duel rounds to which they are entitled (e.g., based on time limit and/or points available). Once the duel ends for both players, the dueling component 180 chooses as the duel victor that player having the higher score. In the event of a tie in score, the dueling component 180 may declare a tie or may pick a duel victor based on a secondary factor (e.g., faster overall time). The dueling component 180 then awards the duel victor with the winning amount, such as by transferring that amount to the victor's profile. By winning duels using skill, a player can accumulate real money in the player's profile.

The computing device on which the blackjack duel system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

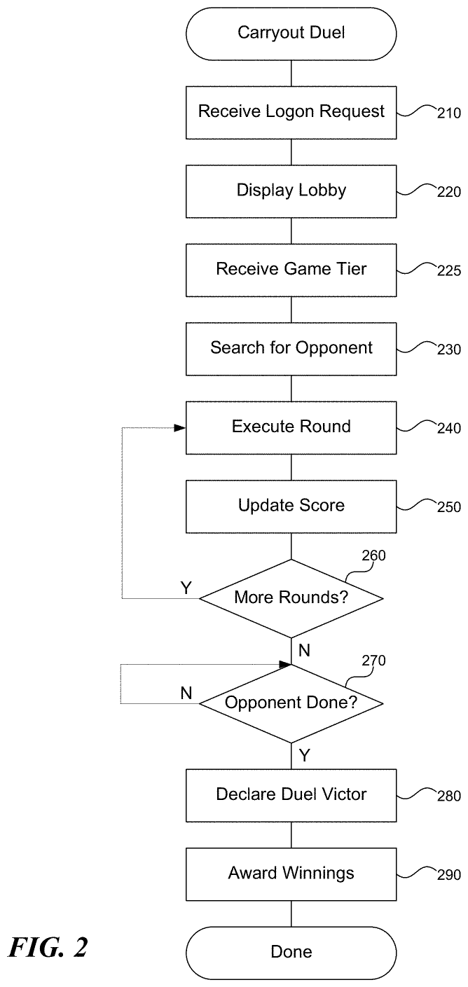

FIG. 2 is a flow diagram that illustrates processing of the blackjack duel system to carry out a duel, in one embodiment. Beginning in block 210, the system receives a logon request from a player and accesses a stored profile of the player to load player information. The player may access the system through a website, a mobile application, or other type of software. The player logs on using authentication information agreed upon by the player and system, such as a username and password, two-factor authentication method, or other type of authentication to prove the player's identity and prevent unauthorized people from accessing the player's profile or acting as the player.

Continuing in block 220, the system displays a game lobby to the logged-on player from which the player selects from multiple game tiers to play in a duel against an opponent. The lobby may include a list or other user interface element to display to the player the game tiers. Game tiers may include free practice tiers as well as paid tiers in which the player pays to enter and stands to win or lose real money. The player deposits money into the player's profile and can use this money to pay entry fees into duels and to receive winnings. The lobby allows the player to select a level of risk and to increase the likelihood of being matched with an opponent at a skill level that the player is comfortable with. More expensive tiers are more likely to house the best players, while lower tiers are more likely to include newer players.

Continuing in block 225, the system receives a game tier selection from the player, which establishes an entry fee that is deducted from the player's stored profile and a winnings amount that the player will receive if the player wins the duel. The selection can be made by clicking a mouse or touching the desired game tier in a touch interface, such as on a mobile phone or tablet. The system may confirm the player's selection to avoid charging the player money if the player made an accidental selection. The selection of the game tier establishes the cost of the duel for the player and the amount that can be won. The cost and amount may be real money for normal duels or game currency for practice duels.

Continuing in block 230, the system searches for the opponent from a plurality of other logged in players that have selected the same game tier as the player and selects one to be the opponent of the player in the duel. The system may select the opponent in variety of ways, from random on one end of a spectrum to very tailored by various selection criteria on the other end of the spectrum. Selection criteria may include skill level to match players of similar skill, familiarity to match players that have played together before or know each other, geography to match players in the same country or region, language to match players that could chat together or communicate in other ways, leaderboard rank to match players that have attained a certain rank, and so forth.

Continuing in block 240, while there are more rounds of gameplay to be played in the duel, the system executes a round of gameplay for the duel with the player, which includes dealing a first quantity of exposed cards, dealing cards to a virtual dealer, dealing cards to the player, receiving wagers from the player, and receiving hit and stand decisions from the player. The exposed cards increase the player's ability to count cards and predict which card will come up next from the unexposed deck. The virtual dealer's hand provides an ability to score the player's performance in the round, by determining whether the player reaches a higher card total than the dealer without going over 21. The player decides with each deal how much to bet and whether to hit (receive another card) or stand (wait for the virtual dealer to be done). The player may also make special decisions, such as to split when two of the same cards are dealt to the player.

Continuing in block 250, the system updates a score for the player after each round that increases when the player wins the round compared to the virtual dealer and decreases when the player loses the round compared to the virtual dealer. The score may be a number of chips that the player started the duel with plus or minus the player's winnings each round.

Continuing in decision block 260, upon determining that there are more rounds the system loops to block 240, else the system continues to block 270. The system determines whether there are more rounds based on an end criterion for the duel. The end criterion may include time for a timed duel, and the duel is over at the expiration of the time. The end criterion may also include score/chips, such that when the player is out of chips the duel ends. The end criterion may also combine these and other criteria to end the duel at a certain point. While the end criterion is not met, the rounds continue.

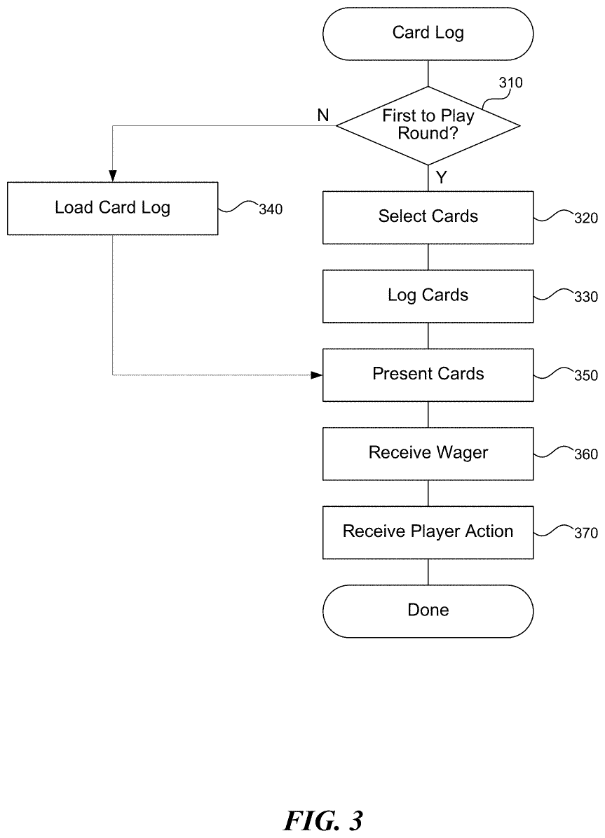

Continuing in decision block 270, the system waits until the opponent is done playing rounds of the duel and then continues at block 280, else the system loops at block 270. The opponent may not play at the same time as the player and the playing of the rounds by the player and opponent may be separated by hours or days. At some point, when both player and opponent are done (reaching the end criteria) the duel ends. The duel may also be played head-to-head such that both player and opponent play at the same time. The system coordinates the play of player and opponent as detailed further in FIG. 3 so that each player receives the same cards each round and faces the same situation and difficulty.

Continuing in block 280, the system declares a duel victor by comparing the player's score and the opponent's score to determine which is greater. The player may achieve a higher score by playing faster (thus having more rounds in the duel and more potential winnings) and by making better decisions (thus having a higher score each round). Each player's skill will allow them to achieve a higher score. The balance of skill and luck can be changed by the game operator by dealing more exposed cards (to allow more card counting), changing the time limits, using more or less decks of cards, and so forth.

Continuing in block 290, the system awards the winnings amount to the duel victor by transferring that amount to the duel victor's stored profile. The winnings amount may be game currency or real money, represented by national currency, bitcoin, or other value. The system may also provide the player and opponent an opportunity to play again and have a rematch so that familiar players can continue playing together. After block 290, these steps conclude.

FIG. 3 is a flow diagram that illustrates processing of the blackjack duel system to deal the same cards to two dueling players, in one embodiment. Beginning in decision block 310, the system determines whether a current player is first to play a current round of a duel; if the current player is first the system continues at block 320, else the system jumps to block 340. A player and opponent each play rounds of the duel and depending on their relative playing speeds either the player or opponent will reach each round first. If the current player is first, the system needs to deal cards for this round for the first time. If the current player is not first, then the system needs to load the cards provided to the opponent for this round to present both players with the same cards.

Continuing in block 320, the system selects cards to deal in the current round of the duel. The system can use a variety of methods for dealing, including using software techniques to randomize the order of the card deck, combining multiple decks, and so forth. The system may also intentionally bias the deck towards face cards up front or face cards in back to allow players to test their skill under various environments. In general, the system will try to mimic in software a real deck of cards and shuffling behavior of a real dealer. The system deals some number of cards exposed to allow for player skill to factor in. The system deals two cards to a virtual dealer (one face up and one face down), and two cards to the player. One card may be face up and one face down or both may be shown to the player, but the value of one card may be hidden from the virtual dealer.

Continuing in block 330, the system logs the cards dealt in the current round of the duel. The system stores a log of cards dealt in each round so that the same cards can be presented to the player and opponent. This puts each player on equal footing and allows the player and opponent to distinguish themselves by wagering and gameplay skill. The player that better predicts which cards will come next, wagers better (higher upon winning and lower upon losing), and plays faster will achieve the highest score. The log may include storing card information to a file, database, cloud-based storage service, or other storage method that can be accessed later when the other player plays the same round of the duel. After block 330, the system jumps to block 350.

Continuing in block 340, the system loads the cards logged when the first player played the current round of the duel. The system may load the cards from a file, database, cloud-based storage service, or other storage method so that the player and opponent both receive the same cards in each round of the duel.

Continuing in block 350, the system presents the cards for the current round of the duel to the player. The system may display a user interface that shows the cards on a virtual table, each card laid in a position that indicates whether it is part of the exposed cards, part of the virtual dealer's cards, part of the player's cards, or part of the remaining undealt cards. The player looks at the player's cards and decides how much to wager and whether to receive additional cards to try to reach a higher card total. The system may display the card total to the player to help the player play more quickly.

Continuing in block 360, the system receives a wager for the current round from the player. The wager is a number of chips that indicate how certain the player is that the player will beat the virtual dealer's hand in the current round. If the player has a higher total than the dealer (but not over 21) at the end of the round, then the player will have the amount of the wager added to the player's score. If the player busts or has a lower total than the dealer at the end of the round, then the player will have the amount of the wager deducted from the player's score.

Continuing in block 370, the system receives an action from the player that indicates whether more cards will be dealt to the player. If the player hits, then the player is dealt another card. If the player stands, then the player is not dealt another card. The player may hit multiple times and be dealt multiple other cards but also risks going over 21 with each hit. After the player is done making decisions and finally stands, then the system finishes the virtual dealer's hand. The virtual dealer may operate under fixed rules, such as always hitting at or below 15 and always standing at or above 16. After the virtual dealer's hand is finished the system determines whether the player beat the virtual dealer and awards or deducts the wager amount from the player. The system then moves on to the next round or if the duel is done finishes the duel. After block 370, these steps conclude.

The following screenshots illustrate an example round of the game provided by the blackjack duel system.

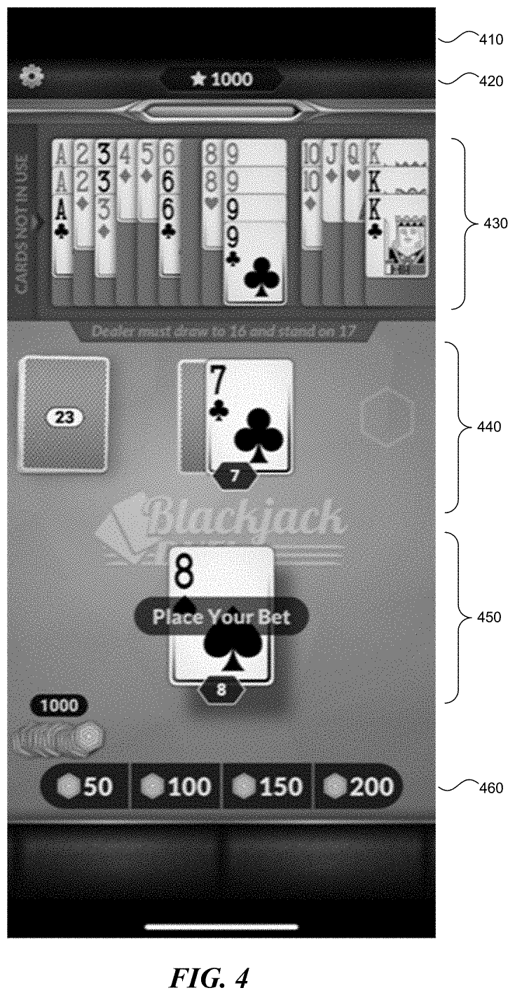

FIG. 4 is a display diagram that illustrates cards dealt in a round of a blackjack duel, in one embodiment. The display 410 includes a score line 420, an exposed cards region 430, a virtual dealer region 440, a player region 450, and betting buttons 460. The score line 420 shows the player's current score of 1000. The score line may be a chip total or (using the alternative scoring method described above or other scoring method) may be a separately calculated score. When the score is not a chip total the chip total may be displayed elsewhere in the display 410, such as near the player's hand. The exposed cards region 430 shows 26 cards that have been dealt face up, visible to the player, at the top. These cards allow the player to predict which card may come next from the deck. The virtual dealer region 440 shows two cards dealt to stand for what would traditionally be a dealer's hand, but there is no real dealer. One of these cards is face up and one face down, in the traditional manner. To the left of the virtual dealer region 440 is a face down deck of 23 remaining cards that remaining cards will be dealt from based on the player's choices. The player region 450 at the bottom shows that the player has been dealt one card face up. Already the player can begin to formulate an idea, using probability theory, of which cards are still hidden based on the 28 cards that are face up for the player to see. At this point the player can place a bet using the betting buttons 460 based on the player's current estimate of likelihood of success in the round. The betting buttons 460 along the bottom allow the user to quickly select common bet amounts of 50/100/150/200 chips.

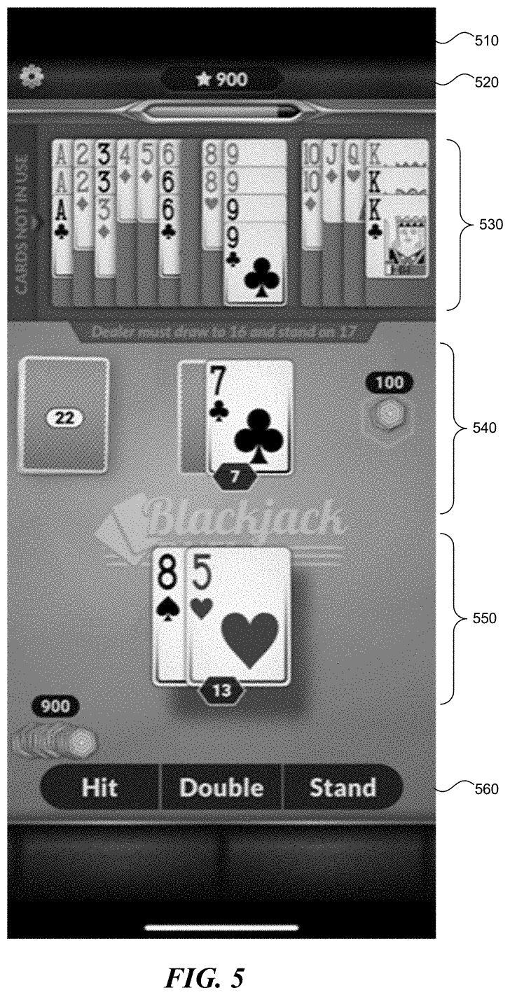

FIG. 5 is a display diagram that illustrates a second dealing of cards in a round of a blackjack duel, in one embodiment. The display 510 includes a score line 520, an exposed cards region 530, a virtual dealer region 540, a player region 550, and action buttons 560. The player has been dealt an additional card and has bet 100 chips so that the player's chip balance is now 900 as shown in the score line 520. The player's bet of 100 chips is shown to the right of the virtual dealer region 540. Both the player and opponent have the exact same conditions on each draw, and the outcome will be the same if both players choose to hit/stop at the same point. If both players also choose to bet the same amount, they both win/lose the same number of chips.

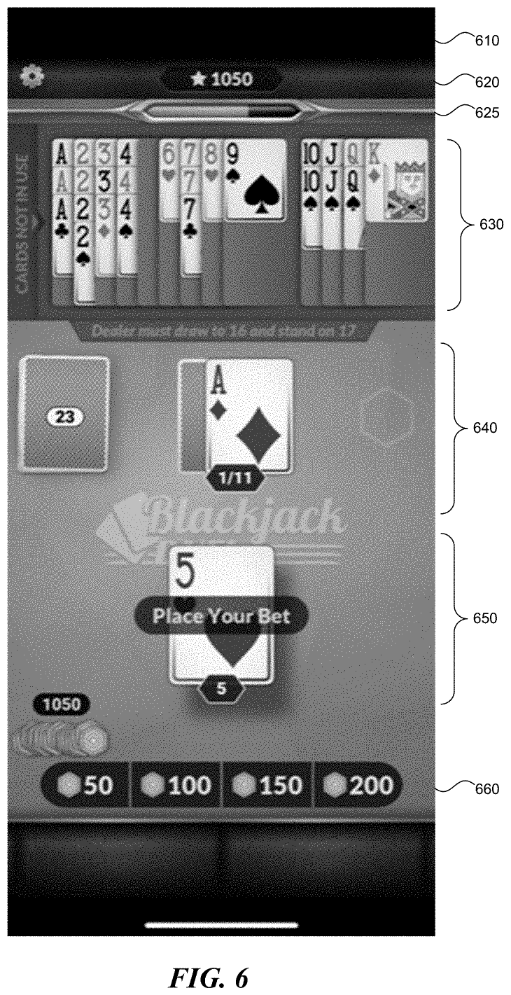

FIG. 6 is a display diagram that illustrates a subsequent round of a blackjack duel, in one embodiment. The display 610 includes a score line 620, a progress bar 625, an exposed cards region 630, a virtual dealer region 640, a player region 650, and betting buttons 660. In the this display 610, a new hand/round has started, and the deck has been reshuffled so that different cards are visible in the exposed region 630, in the virtual dealer region 640, and in the player region 650. The player won chips on the last round so the player's total has increased to 1,050 as shown on the score line 620. In this variation, each hand is timed and the progress bar 625 at the top moves to the right to show how much time is left for the player to make decisions and be dealt more cards. When the progress bar 625 is filled, time expires, and the outcome is determined based on how well the player's hand stacks up against the virtual dealer's hand. If both the player and opponent use the open cards to estimate and play optimal play, the player who can read the cards faster than the opponent probably wins since that player has time to play more rounds. However, playing more rounds does not necessarily mean that a player wins more rounds, the outcome of a round could be a loss even if all cards are displayed.

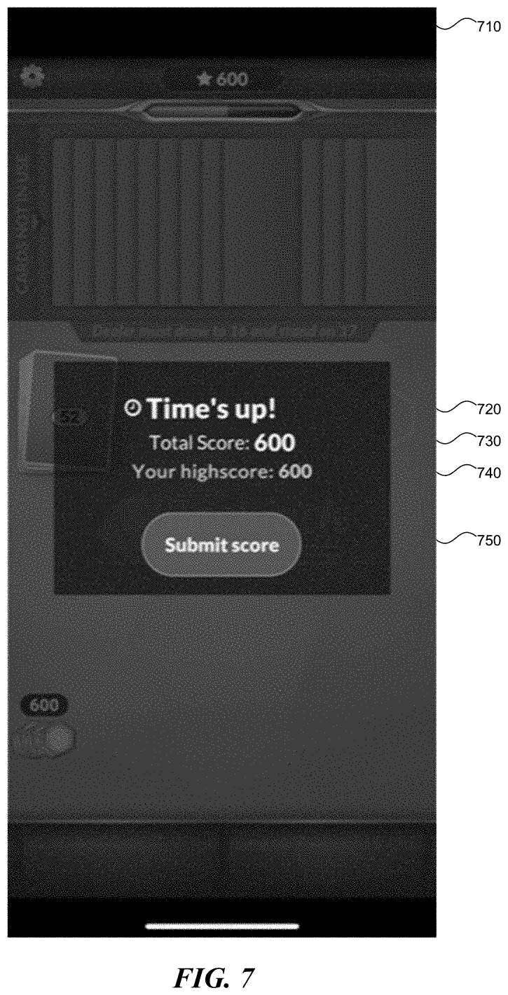

FIG. 7 is a display diagram that illustrates a conclusion of a blackjack duel for one player, in one embodiment. The display 710 includes a message 720, a final score 730, a high score 740, and a button 750. The message 720 indicates that time for playing rounds has expired. The final score 730 has a value of 600. The high score 740 also has a value of 600, and the button 750 allows the player to submit the score for determining the outcome of the duel. In embodiments in which a score is calculated separately from the chip total, the display 710 may include a lines to display the chip total and score separately. It is possible that the player has finished first and that the opponent has not finished yet or may not have even started yet if the two players play at separate times. When the opponent finishes, a final score and outcome can be shown to each player. If the current player is the second player to finish and the round is complete, then the player may be shown “you won” or “you lost” for the message 720 to indicate how he or she did against the opponent. As each player plays, the player's bankroll will grow as the player wins and shrink as the player loses.

From the foregoing, it will be appreciated that specific embodiments of the blackjack duel system have been described here for purposes of illustration, but that various modifications may be made without deviating from the spirit and scope of the invention. Accordingly, the invention is not limited except as by the appended claims.

I/we claim:

1. A computer-implemented method to carry out a blackjack duel in a blackjack duel system, the method comprising:
receiving a logon request from a player and accessing a stored profile of the player to load player information;
displaying a game lobby to the logged-on player from which the player selects from multiple game tiers to play in the duel against an opponent;
receiving a game tier selection from the player, which establishes an entry fee that is deducted from the player's stored profile and a winnings amount that the player will receive if the player wins the duel;
searching for the opponent from a plurality of other logged in players that have selected the same game tier as the player and selecting one other logged in player to be the opponent of the player in the duel;
while there are more rounds of gameplay to be played in the duel, executing a round of gameplay for the duel with the player, which includes dealing a first quantity of exposed cards, dealing cards to a virtual dealer, dealing cards to the player, receiving wagers from the player, and receiving hit and stand decisions from the player;
updating a score for the player after each round that increases when the player wins the round compared to the virtual dealer and decreases when the player loses the round compared to the virtual dealer;
upon determining that there are no more rounds for the player in the duel, waiting for the opponent to finish the opponent's rounds in the duel;
after both the player and opponent have finished all rounds of the duel, declaring a duel victor by comparing the player's score and the opponent's score to determine which is greater; and
awarding the winnings amount to the duel victor by transferring that amount to the duel victor's stored profile, wherein the preceding steps are performed by at least one processor.

2. The method of claim 1 wherein receiving the logon request comprises accessing the blackjack duel system through a mobile application on a mobile device and receiving authentication information from the player.

3. The method of claim 1 wherein displaying the game lobby comprises displaying a list of game tiers including free practice tiers and paid tiers in which the player pays to enter and stands to win or lose real money.

4. The method of claim 1 wherein receiving the game tier selection comprises touching the desired game tier in a touch interface on a mobile phone or tablet.

5. The method of claim 1 wherein searching for the opponent comprises selecting an opponent randomly from the other logged in players.

6. The method of claim 1 wherein searching for the opponent comprises selecting an opponent by matching the opponent's skill to the player's skill.

7. The method of claim 1 wherein executing a round of gameplay comprises selecting a number of exposed cards to increase the player's ability to count cards and predict which card will come up next from the unexposed deck.

8. The method of claim 1 wherein determining there are no more rounds comprises determining that a time limit for the player to play the duel has expired.

9. The method of claim 1 wherein determining there are no more rounds comprises determining that the player does not have sufficient score to play another around.

10. The method of claim 1 wherein awarding the winnings amount comprises transferring an amount of real currency to the duel victor's stored profile.

11. A computer system for facilitating a blackjack duel between a player and an opponent, the system comprising:
a processor and memory configured to execute software instructions embodied within the following components;
a profile component that manages profile information for each user of the system, including a username, login information, and winnings balance;
a lobby component that presents multiple game tiers to the player from which the player selects one tier, wherein each tier has a different entry fee and winning amount that the player will win if the player wins a duel;
a matchmaking component that finds the opponent for the player based on the selected game tier so that the player and the opponent can enter a duel, each duel having multiple rounds;
a dealing component that deals cards for each duel round and tracks the cards dealt to present the same cards to the player and opponent for each duel round;
a betting component that receives from the player a bet for each duel round indicating an amount to be won or lost based on whether the player wins the duel round;
a scoring component that accumulates a player duel score and opponent duel score after each duel round that indicates a relative performance of the player and opponent; and
a dueling component that determines when the duel ends, identifies a duel victor, and awards the winning amount of the selected game tier to the duel victor.

12. The system of claim 11 wherein the lobby component displays tiers where each tier has an entry fee that is slightly more than half of the winning amount, such that the player and opponent in a duel pay enough to fund the winnings for the duel victor and pay the operator of the system a profit for operating the system.

13. The system of claim 11 wherein the lobby component displays one or more free tiers that use game currency and one or more paid tiers that use real money.

14. The system of claim 11 wherein the matchmaking component finds the opponent based on at least one of random selection, matching players of similar skill, matching players by past familiarity, matching players by geographic location, and matching players by language.

15. The system of claim 11 wherein the dealing component stores a log of which cards are dealt in each round so that the player and opponent can play at different times and be presented the same cards.

16. The system of claim 11 wherein the dealing component selects a number of cards to be dealt exposed such that the player and opponent can use card counting skill to achieve a higher score.

17. The system of claim 11 wherein the scoring component tracks game points during a duel to indicate who is more successful between the player and opponent based on wager amount and outcome against the virtual dealer.

18. The system of claim 11 further comprising a time component that places a time limit on the duel and ends duel rounds after the time limit expires.

19. The system of claim 11 wherein the duel component ends the duel based on a time limit expiring or a player exhausting points to bet with.

20. A computer-readable storage medium comprising instructions for controlling a computer system to deal the same cards to a player and an opponent in a blackjack duel where the player and the opponent play at different times, wherein the instructions, upon execution, cause a processor to perform actions comprising:
determining whether the player is first to play a current round of the duel;
if the player is first,
selecting cards to deal in the current round of the duel; and
logging the cards dealt in the current round of the duel to a storage device;
if the player is not first,
loading from the storage device the cards logged when the opponent played the current round of the duel;
presenting the cards for the current round of the duel to the player;
receiving a wager for the current round from the player; and
receiving an action from the player that indicates whether more cards will be dealt to the player.
